(19) United States
(12) Patent Application Publication
(10) Pub. No.: US 2026/0030451 A1
(43) Pub. Date: Jan. 29, 2026

(54) Computer System, Computer-Implemented Method, And Computer Readable Media For Selecting Functions To Prompt A Large Language Model (LLM)

(71) Applicant: Shopify Inc., Ottawa (CA)

(72) Inventor: Dianing Galih YUDONO, Sutton (GB)

(73) Assignee: Shopify Inc., Ottawa (CA)

(21) Appl. No.: 18/785,051

(22) Filed: Jul. 26, 2024

(51) Int. Cl. G06F 40/284; G06F 16/33; G06F 16/35

(52) U.S. Cl. CPC G06F 40/284; G06F 16/3347; G06F 16/35

(57) ABSTRACT

A system and method are provided for function selecting when prompting a large language model (LLM). The method includes receiving an input for the LLM and selecting one or more functions from a set of functions based on the input. The method also includes generating a prompt based on the input and the selected one or more functions and providing the prompt to the LLM and obtaining a response.

### TECHNICAL FIELD

The following relates generally to prompting LLMs and, in particular, to selecting functions for prompting such LLMs, for example, to select functions from a set of functions based on an input.

### BACKGROUND

When prompting an LLM, e.g., to perform a task or to provide a recommendation based on a set of tools or functions to perform the task, there may be restrictions on how much information can be passed to the LLM. For example, function calling using an LLM may involve passing a tools parameter, which includes a number of functions from which the LLM can choose to complete a specific task.

### BRIEF DESCRIPTION OF THE DRAWINGS

Embodiments will now be described with reference to the appended drawings wherein:

FIG. 1 is an example of a computing environment in which an LLM prompt is generated based on an input.

FIG. 2 is an example of a configuration for selecting one or more functions from a set of functions.

FIG. 3 is an example of a computing device operable to communicate in the computing environment.

FIG. 4 illustrates an example of a set of tools.

FIG. 5 illustrates an example of a response to an LLM prompt.

FIG. 6 is a flow chart illustrating example operations for selecting functions to prompt an LLM.

FIG. 7 is a flow chart illustrating example operations for comparing information parsed from an input to information parsed from a set of functions to select one or more functions to prompt an LLM.

FIG. 8 is a flow chart illustrating example operations for performing a vector similarity search using vector representations of a query in an input to vector representations of a set of functions.

FIG. 9 is a flow chart illustrating example operations for re-prompting an LLM when a first pass does not generate a recommendation.

FIG. 10 illustrates an example user query used to generate an input for selecting functions to prompt an LLM.

FIG. 11 illustrates a response to the user query shown in FIG. 10.

FIG. 12 is a block diagram of a simplified convolutional neural network, which may be used in examples of the present disclosure.

FIG. 13 is a block diagram of a simplified transformer neural network, which may be used in examples of the present disclosure.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

Certain limits may be encountered when using an LLM for function calling. For instance, there may exist a token limit where the model's context limit can be quickly exhausted when a large number of functions is defined, because each function counts towards the input tokens. There may be, additionally or alternatively, a function limit where a model has a hard limit on the number of functions that can be included in each LLM prompt. Static lists of functions may lead to inefficiencies since token and compute resources may be spent on storing and referencing irrelevant functions. Moreover, the model may have difficulty choosing a function when there are too many options, and/or may produce hallucinations due to its attention being spread too thin. It has also been found that, in some cases, models may tend to bias towards functions located at the extremes of the prompt due to the sequence in which the functions are presented.

The above challenges may be considered a problem associated with having a relatively larger set of input functions or choices for an LLM than is reasonable or permitted to pass to the LLM in a given prompt. To address this problem, a computer system and computer-implemented method may be utilized that apply a function selection process when prompting an LLM by parsing a user query and comparing the parsed query to the functions directly, or by comparing the parsed query to groups or clusters of functions that have been similarly classified, embedded or otherwise categorized as such.

The system and method may be configured to select from a set of multiple functions that may be passed to an LLM. This may be done to determine which function or functions are recommended to be used to perform a task. The functions each typically include a function definition that specifies a detailed description of the function and its parameters. In one example, these functions may be written in JSON format.

For example, a “tools” parameter may exist, which includes the functions that an LLM may choose from, e.g., to select a function to call, or to determine a recommendation for another entity to perform the task by making a function call. A subset of a larger set of functions may be grouped, clustered or individually selected to be passed to the LLM. The LLM may select a function from the set of tools based on the user query or some other additional information such as contextual data from a conversation chat message or from an application being used.

To determine one or more functions (e.g., a subset of functions) from the larger set of functions, the function definitions may be analyzed dynamically in real-time (prior to prompting the LLM) or may be preprocessed to increase the efficiency of this operation. For example, the function description and other relevant fields of each function may be converted into a vector representation using a text-to-vector embedding algorithm, e.g., ada or E5. Additionally or alternatively, other preprocessing may be applied, for example, by classifying the function using a machine learning classifier or by utilizing a model such as another LLM.

The functions may be clustered or grouped based on the embeddings or classifications or may be grouped based on some other operation that organizes, groups, or tags the functions. The grouping or clustering may assist in determining the subset of functions to pass when prompting the LLM. Alternatively, subsets of functions may be selected from the larger set of functions dynamically in real-time based on the preprocessing.

The user query received as the input that triggers the proposed solution may be analyzed and categorized to determine a classification or embedding that may be compared to the classification or embeddings determined in the preprocessing of the functions. Generally, the user query may be parsed to obtain data and information that may be used to select the subset of functions from the larger set of functions according to the methods utilized in preprocessing the functions, e.g., by comparing information determined from parsing the functions with information determined from parsing the input (including a user query, contextual information, commands, etc.).

The user query may be categorized or otherwise processed using various methods. Such methods may include, without limitation, a rule-based method based on pattern matching that uses regular expressions or predefined patterns to identify specific keywords or phrases that correspond to different types of tasks; machine learning models based on text classification where a supervised machine learning model (e.g., Naïve Bayes, Support Vector Machines, Logistic Regression, etc.) is trained on labeled data where each input is tagged with a task type; or intent recognition that uses natural language understanding (NLU) frameworks such as Dialogflow™, Rasa™, or Microsoft® LUIS to build models that can recognize user intents (types of tasks) based on the input text.

In one example, the user query may be classified using a machine learning classifier or another model such as a smaller LLM having fewer parameters. In another example, the user query may be embedded into a vector and a vector similarity search conducted against all function embeddings stored in a vector database. The “n” nearest function embeddings may be retrieved and used as the subset of functions passed to the LLM. That is, the vector similarity search may be used to create a group or cluster of functions rather than rely on a pre-clustering or pre-grouping of the functions. Generally, the user query (and/or other portions of the input) may be used to reduce the larger set of functions to a subset of relevant functions to be passed to the LLM. This may be done by parsing the user query and comparing the user query to the function definitions according to the classification or similarity operation used in processing the functions.

In one aspect, there is provided a computer-implemented method, comprising receiving an input for an LLM, selecting one or more functions from a set of functions based on the input, generating a prompt based on the input and the selected one or more functions, and providing the prompt to the LLM and obtaining a response.

In certain example embodiments, the one or more functions may be selected based on a limit associated with the input.

In certain example embodiments, the one or more functions may be selected based on a limit associated with the LLM.

In certain example embodiments, the limit may include a token input limit.

In certain example embodiments, the one or more functions may be selected based on a limit associated with a number of functions.

In certain example embodiments, a total number of functions in the set of functions is above an input limit of the LLM.

In certain example embodiments, the selected one or more functions may correspond to a particular group of a plurality of groups of functions drawn from the set of functions.

In certain example embodiments, the plurality of functions are categorized into the plurality of groups using data associated with each function.

In certain example embodiments, the data associated with each function may include a function definition.

In certain example embodiments, each of the functions in the set of functions may include a vector representation generated using a text-to-vector embedding process.

In certain example embodiments, the plurality of groups are formed by clustering function embeddings.

In certain example embodiments, the plurality of groups are clustered using a vector similarity search.

In certain example embodiments, the method may include parsing the input to determine information used in selecting the one or more functions.

In certain example embodiments, the input may be parsed to determine one of a plurality of categories using a machine learning classifier.

In certain example embodiments, the input may be parsed to determine one of a plurality of categories using a separate LLM.

In certain example embodiments, each of the functions in the set of functions has been parsed to enable that function to be selected as one of the one or more functions using the information.

In certain example embodiments, each of the functions in the set of functions has been parsed to determine one of a plurality of categories using a machine learning classifier or a separate LLM.

In certain example embodiments, the input may include a user query associated with a task to be completed.

In certain example embodiments, the input may include contextual data obtained from a chat conversation.

In certain example embodiments, each of the functions in the set of functions may include a vector representation generated using a text-to-vector embedding process, and wherein the input comprises a query, and the method may include embedding the query into a vector representation; and performing a vector similarity search using the vector representation of the query and the vector representations of the set of functions.

In certain example embodiments, the query may be parsed using a separate LLM to obtain a description of a function capable of processing the query, the description being used to embed the query into the vector representation.

In certain example embodiments, the response may indicate that a recommended one of the selected one or more functions identified from the prompt could not be determined by the LLM, and the method may include re-selecting one or more functions from the set of functions and re-prompting the LLM.

In another aspect, there is provided a computer system comprising at least one processor and at least one memory, the at least one memory comprising processor executable instructions that, when executed by the at least one processor, cause the computer system to receive an input for an LLM, select one or more functions from a set of functions based on the input, generate a prompt based on the input and the selected one or more functions, and provide the prompt to the LLM and obtaining a response.

In another aspect, there is provided a computer-readable medium comprising processor executable instructions that, when executed by a processor of a computer system, cause the computer system to receive an input for an LLM, select one or more functions from a set of functions based on the input, generate a prompt based on the input and the selected one or more functions, and provide the prompt to the LLM and obtaining a response.

### Selecting Functions to Prompt an LLM

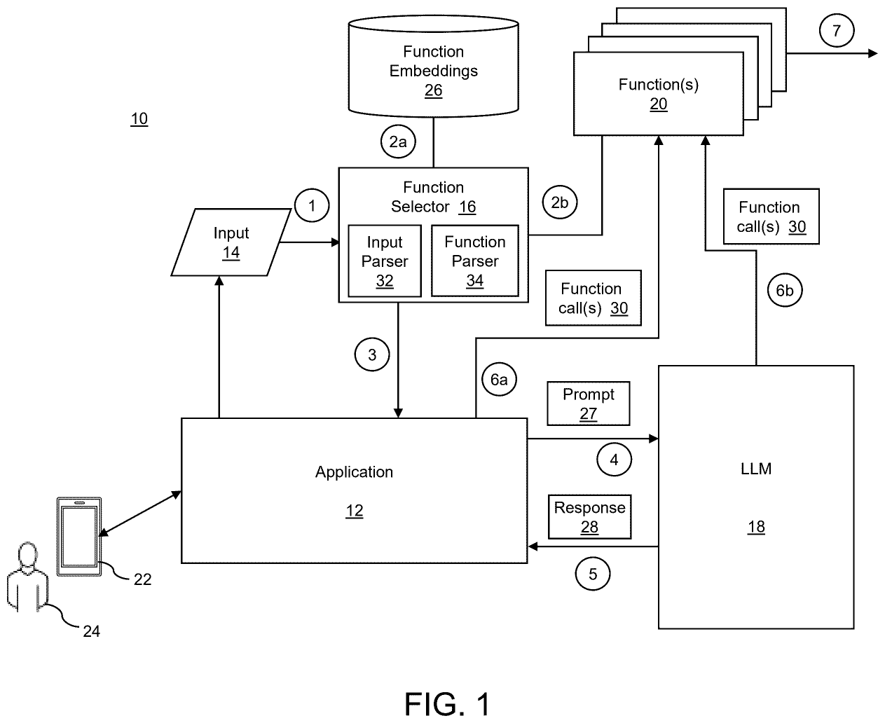

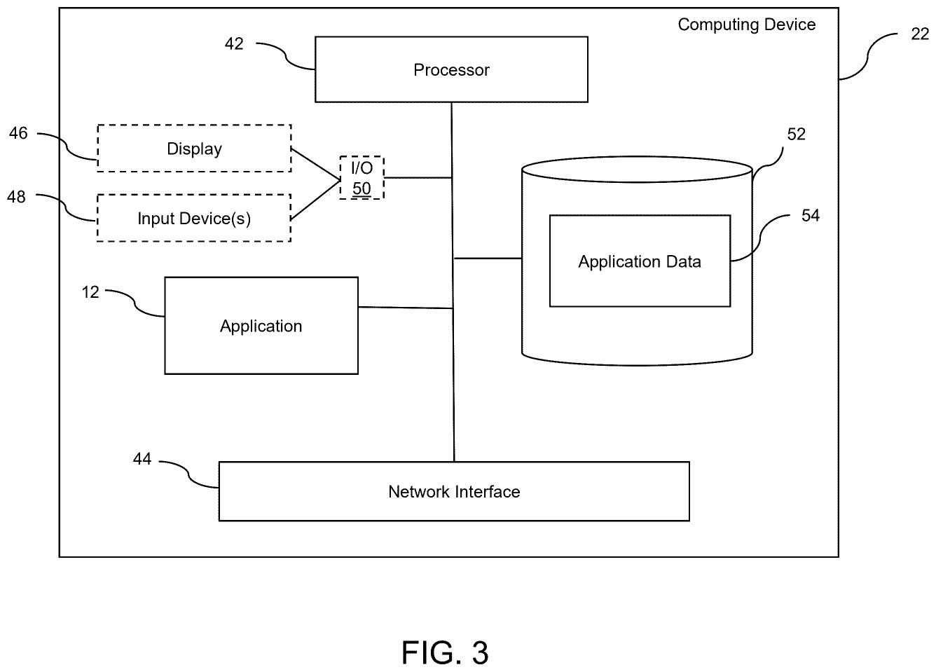

Referring now to the figures, FIG. 1 illustrates an example of a computing environment 10 in which an application 12 is provided by or in communication with one or more computing devices 22 or computing systems (see also FIG. 3). As illustrated in FIG. 1, the application 12 may be running on the computing device 22 (e.g., on a smartphone or tablet) or the computing device 22 may be in communication with the application 12 as it is hosted by/on a different computing device 22, e.g., a server device or other computer or computer system.

Such computing devices 22 (or computing systems) may include, but are not limited to, a mobile phone, a personal computer, a laptop computer, a server computer, a tablet computer, a notebook computer, a hand-held computer, a personal digital assistant, a portable navigation device, a wearable device, a gaming device, an embedded device, a virtual reality device, an augmented reality device, etc.

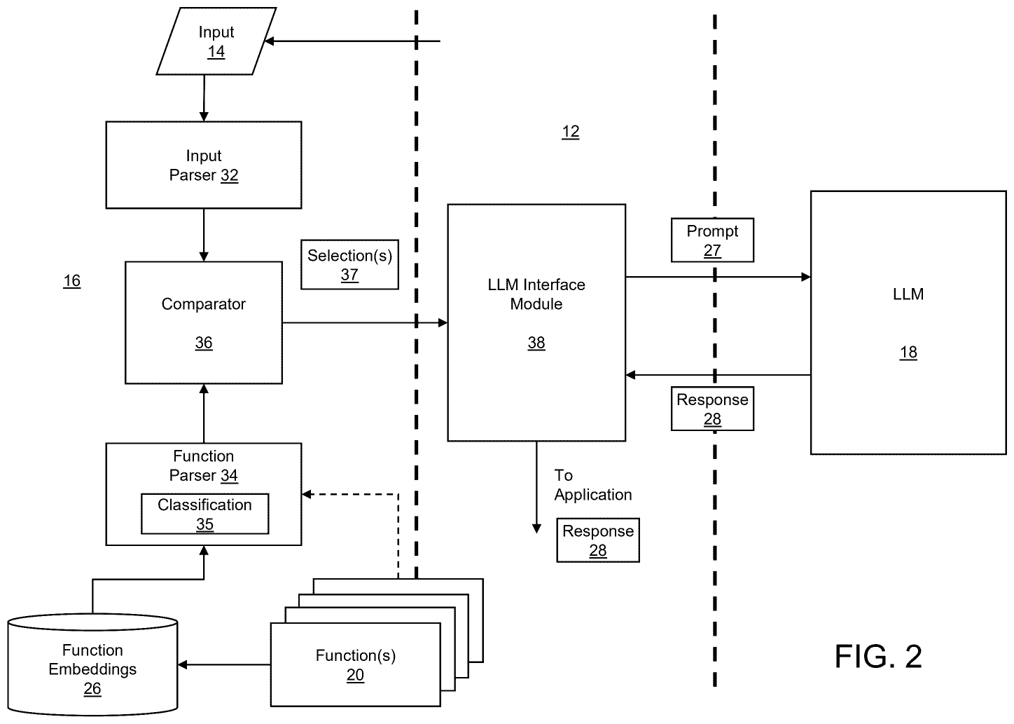

The application 12 includes or is in communication with a function selector 16. The function selector 16 is used by the application 12 or acts on behalf of a separate entity to process an input 14 to determine one or more functions 20 from a set of functions 20 to be used by the application 12 in generating a prompt 27 for an LLM 18. The function selector 16 includes or otherwise has access to a repository, data storage element, database or other source that provides or implements the set of functions 20. The functions 20 may be used to perform certain tasks or to execute certain actions in response to function calls 30, which may be initiated by the LLM 18 or the application 12. In other example implementations, such function calls 30 may, additionally or alternatively, be executed by some other entity for or on behalf of the application 12 or LLM 18. The application 12 may include or have access to an LLM interface module 38 (see FIG. 2), which may serve as a widget, tool, plug-in, function, script, or other computer program that is embodied as a stand-alone routine or may be integrated with the application 12 to execute an exchange of data and/or information with the LLM 18.

In this example, the application 12 uses the function selector 16 to select one or more functions 20 from a set of functions 20 to use in generating a prompt for the LLM 18 to assist with or otherwise supplement information or instructions associated with an exchange with a user 24 (or other entity) to obtain information from or using the LLM 18. The LLM 18 may, for example, be used to recommend a certain function 20 from the one or more selected functions 20 to use for executing a particular task. The exchange of the prompt 27 and response 28 may be initiated based on a query originating from an interaction between the user 24 and the application 12 using the computing device 22. For example, the user 24 may engage in a chat session with a chatbot, with the chatbot being included in or embodied by the application 12 to interact with the user 24. In such an example, the application 12 may receive text or other multimedia messages from the user 24 and interact with the function selector 16 to select one or more functions 20 in a set of functions 20 to use in generating a prompt 27 for the LLM 18 to obtain information such as a recommended function call 30 to trigger or initiate the execution of the particular function 20.

As noted above, the application 12 may be hosted by, or otherwise run on, the computing device 22, or may be accessed by the computing device 22 over a communication network (not shown). Such communication network(s) may include a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The application 12 may take the form of a mobile-type application (also referred to as an “app”—as illustrated), a desktop-type application, an embedded application in customized computing systems, or an instance or page contained and provided within a web/Internet browser, to name a few.

The LLM 18 may be provided by a separate computing device 22 or computing system, by a separate entity or may be integrated with the application 12 within the same computing device 22 or computing system. As such, the configuration shown in FIG. 1 is illustrative and other computing device/system configurations are possible. For example, the computing environment 10 shown in FIG. 1 may represent a single device such as a portable electronic device or the integration/cooperation of multiple electronic devices such as a client device and server device or a client device and a remote or offsite storage or processing entity or service. That is, the computing environment 10 may be implemented using any one or more electronic devices including standalone devices and those connected to offsite storage and processing operations (e.g., via cloud-based computing storage and processing facilities).

The function selector 16 in this example includes or has access to a data store or database containing function embeddings 26. The function embeddings 26 include representations of information (e.g., numerical) that capture their semantic meaning. For example, the function embeddings 26 may take the form of a vector representation to allow an embedding 26 of a particular function 20 be subjected to a vector similarity search. The function embeddings 26 are one example of how the function selector 16 may utilize a function parser 34 to determine information about each function 20 to enable a contextualized selection or elimination of certain one or more functions 20 from a set of functions 20. The functions 20 and/or the function embeddings 26 may additionally be sorted, organized, classified or grouped. For example, a set of tools that define functions for determining a weather forecast or current weather outlook may be grouped together such that a user query related to weather may be matched with the weather grouping. The weather grouping may include any plurality of functions 20, for example, a temperature forecasting function 20, a weather radar function 20, a time of day (e.g., sunrise, sunset, etc.) function 20, and a precipitation function 20. The grouping may also be determined dynamically based on a classification that associates the function 20 with “weather”. In this way, other associations may be accounted for. For example, “time of year” may be associated with a function 20 related to determining or predicting weather depending on the horizon of the forecast.

As indicated above, the function selector 16 may be used to limit the number of functions 20 passed to the LLM 18 by the application 12 in a prompt 27, wherein the limit may be imposed by the LLM 18 or some other constraint. Limiting the number of functions 20 passed to the LLM 18 in a prompt 27 may, additionally or alternatively, be done to reduce computational complexity for the LLM 18 or otherwise improve speed or efficiency of a system, including operations performed for or by the application 12.

The function selector 16 may use the function parser 34 to determine information about the functions 20 that can be compared to some contextual baseline or other information associated with or gleaned from the input 14. That is, the input 14 may be parsed by an input parser 32 to determine information or some context associated with the input 14 to assist in making selections from the set of functions 20. The input parser 32 may be utilized and operated by the function selector 16 as shown in FIG. 1 or may alternatively be utilized and operated by the application 12 to provide additional information about the input 14 to the function selector 16. The input 14 may include, without limitation, a query, command, request, data point, dataset, contextual metadata, or selection that is generated by or for the application 12. For example, the input 14 may include a user query obtained from a chat message. The input 14 may, additionally or alternatively, include contextual data such as prior messages, an application type, a query type or other context that may be useful in categorizing or classifying the input 14. The input parser 32 may process the input 14 to generate embeddings for the input 14 (e.g., using a text-to-vector embedding process) or may otherwise parse at least a portion of the input 14 to determine a category or class that allows for comparison with the embeddings 26 or other information parsed from the functions 20. For example, a text-based user query contained in the input 14 may be parsed to identify a task to be executed, and the task be classified, to determine a sub-set of functions 20 that relate to such a task.

FIG. 1 illustrates two example workflow paths for generating, triggering, or initiating the execution of function calls 30 responsive to an input 14 and based on utilization of the function selector 16. At operation 1, the function selector 16 obtains the input 14. In this example, the input 14 originates from the application 12, e.g., based on an interaction with the computing device 22 by a user 24. The input 14 may be pushed from the application 12 to the function selector 16 or may be pulled from the application 12 by the function selector 16 responsive to a trigger or event. The function selector 16 may parse the functions 20 in two different manners in this example. At operation 2a, the function selector 16 may rely on preprocessing of the functions 20 that has generated the function embeddings 26 or has classified the functions 20 or grouped the functions 20. The function selector may, additionally or alternatively, be capable of parsing the functions 20 and any information associated with the functions 20 using operation 2b, in real-time, responsive to obtaining the input 14. Based on the input 14, any parsing of the input 14 applied by the function selector 16 using the input parser 32, and information determined by parsing the functions 20, the function selector 16 may select one or more functions 20 from a set of functions 20 and provide selection(s) 37 (see also FIG. 2) at operation 3 to enable the application 12 to generate a prompt 27 at operation 4. That is, rather than passing all functions 20 or a relatively larger set of functions 20 to the LLM 18, the function selector 16 may be utilized to selectively reduce the number of functions 20 to pass to the LLM 18 in a prompt 27 based on the input 14.

At operation 5, the LLM 18 returns a response 28 to the application 12 based on the prompt 27. For example, the LLM 18 may have been asked by the prompt 27 to recommend a function 20 from the selected functions 37 (see also FIG. 2) determined by the function selector 16, for performing a particular task. As such, the prompt 27 may include other information such as contextual data including the task, the task type, or metadata associated with or included in the input 14 (or the entire input 14 itself). In this way, the LLM 18 may generate a recommendation or other reply to a request included in the prompt 27 by returning a response 28 to the application 12.

The response 28 may be used by the application 12 in the workflow path beginning with operation 6a or may be used by the LLM 18 directly in the workflow path beginning with operation 6b to generate one or more function calls 30. That is, the LLM 18 may be used to directly initiate a function call 30 based on the selection or recommendation made by passing the prompt 27 to the LLM 18 and receiving the response 28 from the LLM 18. In this scenario, the response 28 may be used to report back to the application 12 regarding the function call 30 initiated by the LLM 18. In the workflow path beginning at operation 6a, the response 28 received by the application 12 at operation 5 may be used to initiate one or more function calls 30.

At operation 7, the function 20 corresponding to the function call 30 may be executed or initiated, e.g., to perform a task requested by the application 12 in generating an answer for the input 14. It can be appreciated that operation 7 may include multiple function calls 30 and such multiple function calls 30 may be executed in parallel or sequentially. For example, the response 28 may return multiple recommendations, which may be trialed one or more at a time, in a particular order, to determine if the requested task can be executed. The application 12 may, additionally or alternatively, analyze multiple recommendations to select a preferred option, e.g., based on a metric such as processing costs, time of execution, availability, storage requirements, etc.

Referring now to FIG. 2, further detail is provided to illustrate an example of how the function selector 16 may utilize the input parser 32 and the function parser 34 to select one or more functions 20 from a set of functions 20 to assist the application 12 in generating the prompt 27. The application 12 may include, as illustrated in FIG. 2, an LLM interface module 38, which may serve as a widget, tool, plug-in, function, script, or other computer program that is embodied as a stand-alone routine or may be integrated with the application 12 to execute an exchange of data and/or information with the LLM 18. As shown, the LLM interface module 38 may be used to send prompts 27 to the LLM 18 and receive responses 28 from the LLM 18 via a suitable connection such as an application programming interface (API) or other software interface.

The LLM interface module 38 in this example may be configured to generate the prompt 27 in an appropriate format or syntax based on the LLM 18 being prompted (e.g., if multiple different LLMs 18 are available to be used). As such, the LLM interface module 38 may receive a set of selections 37, which includes a list of one or more functions 20 selected from a set of functions 20 by the function selector 16, e.g., by a comparator 36 as shown in this example. It can be appreciated that the delineation between the comparator 36 and LLM interface module 38 is shown for illustrative purposes and the operations performed by these entities may be done by more or fewer modules or by a general processor associated with the function selector 16, application 12 or computing device 22. That is, the configurations shown in FIGS. 1 and 2 are for the purpose of illustration and should not be considered limiting.

The LLM interface module 38 may be coupled to or otherwise be capable of communicating with the application 12 to relay or hand over the response 28 to another destination, as discussed above. The selections 37 provided by the comparator 36 are based on the comparison of information determined from the input 14 by the input parser 32 with information determined from the functions 20 by the function parser 34. The function parser 34 may include a classification module 35 to classify the functions 20 using a machine learning classifier or second LLM (not shown). This may be done directly from the functions 20. The classified functions 20 may, additionally or alternatively, be organized into groupings such that each group of functions 20 is associated with a particular type of function 20 or may be used for particular types of tasks, etc.

As discussed above, the function parser 34 may utilize function embeddings 26 to perform a similarity search by comparing, for example, vector representations, with embeddings generated from the input 14 by the input parser 32. For example, the comparator 36 may use vector embeddings generated from the input 14 (e.g., by parsing a text-based query) to perform a vector similarity search against the function embeddings 26 to determine one or more functions 20 that satisfy a distance criterion. In general, the input parser 32 may be used to determine information from the input 14 that can be compared to information determined from the functions 20, to make one or more selections 37 appropriate to the nature of the input 14. In another example, the input parser 14 may be used to parse data and information from the input 14 to determine information that may be classified for the purpose of comparison to certain groupings of functions 20 that have been determined as noted above. Further details regarding various techniques that may be utilized are provided below.

FIG. 3 shows an example of a computing device 22, which may be utilized by any one or more of the entities shown in FIGS. 1 and 2, for example, a personal electronic device or server used to provide the application 12 or other computing device 22 used to communicate with the LLM 18 and to utilize the function selector 16. The computing device 22 in FIG. 3 may, additionally or alternatively, provide an example of a device on which the LLM 18 may be deployed or accessed and/or on which the function selector 16 may be deployed or accessed by the application 12 residing on another computing device 22.

In this example, the computing device 22 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 22 may also include the application 12 (or other application(s)), a data store 52, and client application data 54. Although not shown in FIG. 3, the function selector 16 may additionally be included in the computing device 22 (e.g., coupled to the application 12) or may be accessible thereto.

The data store 52 may represent a database or library or other computer-readable medium configured to store data and permit retrieval of data by the computing device 22. The data store 52 may be read-only or may permit modifications to the data. The data store 52 may also store both read-only and write accessible data in the same memory allocation. In this example, the data store 52 stores the application data 54 for the application 12 that is configured to be executed by the computing device 22 for a particular role or purpose.

While not delineated in FIG. 3, the computing device 22 includes at least one memory or memory device that can include a tangible and non-transitory computer-readable medium having stored therein computer programs, sets of instructions, code, or data to be executed by processor(s) 42. The processor(s) 42 and network interface(s) 44 are connected to each other via a data bus or other communication backbone to enable components of the computing device 22 to operate together as described herein. FIG. 3 illustrates examples of modules and applications stored in memory on the computing device 22 and executed by the processor(s) 42.

It can be appreciated that any of the modules and applications shown in FIG. 3 may be hosted externally and may be available to the computing device 22, e.g., via a network interface 44. The data store 52 in this example stores, among other things, the application data 54 that can be accessed and utilized by the application 12 and/or app module 14. The data store 52 may additionally store one or more software functions or routines in a cache or in other types of memory (e.g., the LLM interface module 38 may be stored in the data store 52 separately from the application 12).

As shown in FIG. 3, the computing device 22 may, optionally (e.g., when configured as a personal electronic device such as a smartphone or tablet), include a display 46 and one or more input device(s) 48 that may be utilized via an input/output (I/O) module 50. That is, such components may be omitted when the computing device 22 does not interact with a user.

While examples referred to herein may refer to a single display 46 for ease of illustration, the principles discussed herein may also be applied to multiple displays 46, e.g., to view portions of Uls rendered by or with the application 12 on separate side-by-side screens. That is, any reference to a display 46 may include any one or more displays 46 or screens providing similar visual functions. The application 12 receives one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user 24 interacting with the computing environment 10, e.g., by operating the computing device 22 as illustrated in FIG. 1.

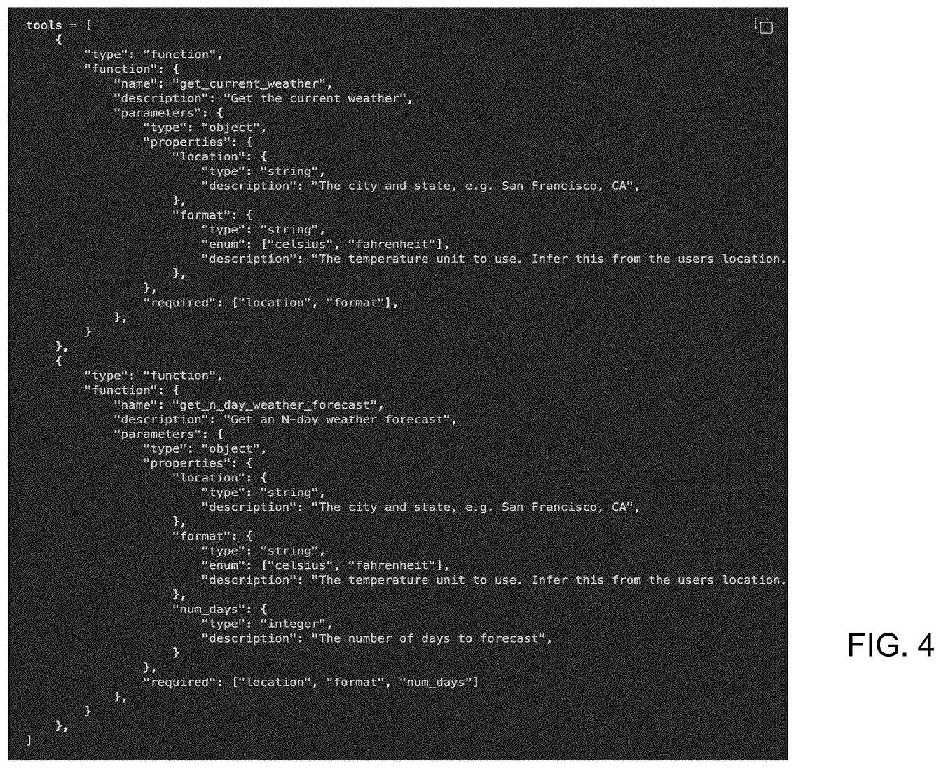

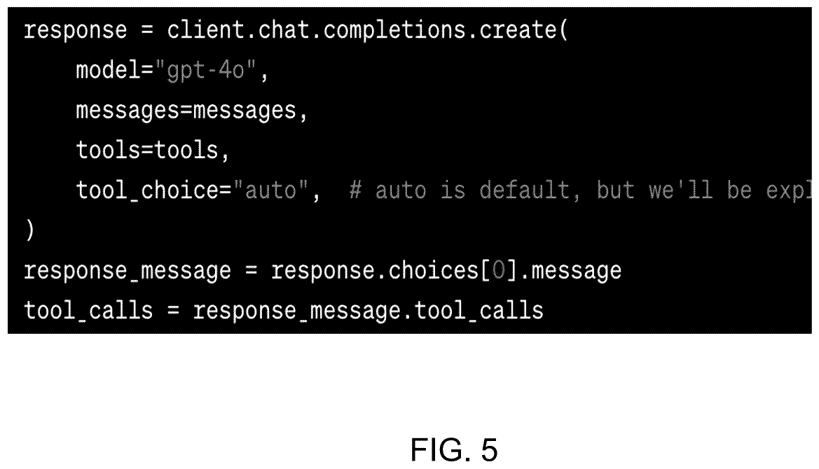

FIG. 4 illustrates an example of a tools definition having multiple function definitions, written in JSON format. In the example shown in FIG. 4, a tools parameter includes the functions 20 that the LLM 18 may choose from in generating a recommendation. Here, two functions 20 are shown by way of example and illustrate a subset of a larger set of functions 20 that may be grouped, clustered or individually selected to be passed to the LLM 18. The LLM 18 may select a function 20 from the tools parameter based on the input 14, for example, a user query or some other additional information such as contextual data from a conversation chat message or an application 12 being used. FIG. 5 illustrates an example of an API request made in passing in tools to an LLM 18.

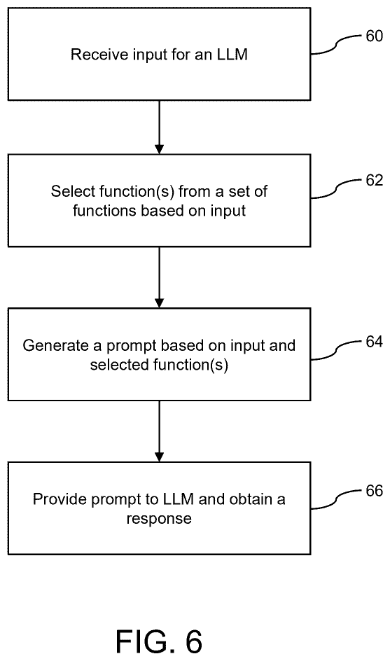

Referring now to FIG. 6, a flow chart is provided illustrating example operations for selecting one or more functions 20 when prompting an LLM 18. The operations shown in FIG. 4 may be implemented by an electronic device (e.g., computing device 22 shown in FIGS. 1 and 3), a server, or other computing system, computing service, or other computing entity in the computing environment 10.

At block 60, an input 14 that is to be used or is for an LLM 18 is obtained by the function selector 16. The input 14 may be provided by an application 12 or may be pulled from such an application 12 or other source.

At block 62, the function selector 16 may select one or more functions 20 from the set of functions 20 based on the input 14. As discussed above, the input 14 may be parsed by the input parser 32 and information determined from the input 14 may be compared with information determined from the functions 20, e.g., based on preprocessing to generate function embeddings 26, groups of similar functions 20 (e.g., as determined by a source of the functions 20 or by applying an analysis) or groupings of the function embeddings 26. The input 14 may, additionally or alternatively, be compared to the functions 20 based on dynamic parsing of the functions 20 using the function parser 34. As illustrated in FIG. 2, the function selector 16 may use a comparator 38 to process information determined by the input parser 32 and the function parser 34.

At block 64, the application 12 may generate a prompt 27 based on the input 14 and by using the selected one or more functions 20. The function selector 16 may utilize an LLM interface module 38 to generate the prompt 27, e.g., to utilize an appropriate format or syntax or to access a certain API depending on the LLM 18 being used.

At block 66, the application 12, e.g., using the LLM interface module 38, provides the prompt 27 to the LLM 18 to obtain a response 28. The response 28 may then be used in the workflow path applicable to the particular scenario, e.g., as illustrated in FIG. 1. The response 28 may therefore be used to have one or more function calls 30 initiated, either by the LLM 18, or the application 12 from which the input 14 originated, or by some other entity.

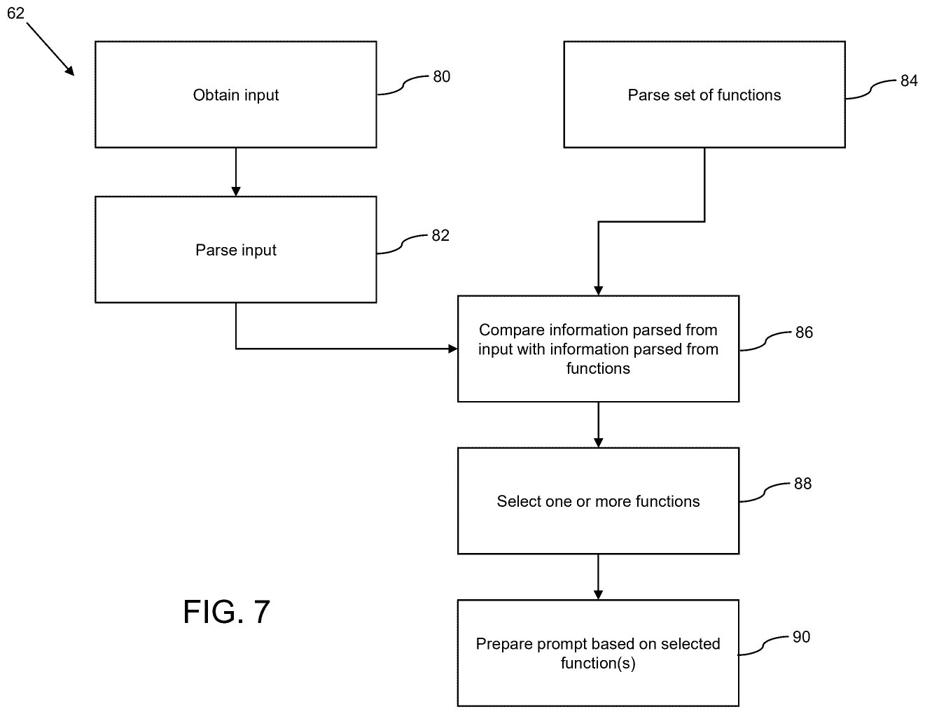

Referring now to FIG. 7, a flow chart is provided illustrating example operations for selecting one or more functions 20 from a set of functions 20, e.g., at block 62 in FIG. 6. The operations shown in FIG. 7 may be performed by the function selector 16, e.g., using a comparator 36 as illustrated in FIG. 2.

At block 80, the input parser 32 obtains the input 14 and, at block 82, parses the input 14. Parsing the input 14 may include applying various techniques. For example, such techniques may include, without limitation, a rule-based method based on pattern matching that uses regular expressions or predefined patterns to identify specific keywords or phrases that correspond to different types of tasks; machine learning models based on text classification where a supervised machine learning model; or intent recognition that uses NLU frameworks as discussed above. From the parsing performed at block 82, the comparator 36 may be provided with information determined from the input 14 that may be compared to information determined from the functions 20.

At block 84, the set of functions 20 is parsed by the function parser 34. As discussed above, the function parser 34 may analyze the functions 20 (e.g., function definitions) directly and in real-time or otherwise dynamically or may rely on some preprocessing such as the preparation of function embeddings 26. The function embeddings 26 may include numerical representations, such as vector embeddings that are capable of being subjected to a vector similarity search. The function embeddings 26 may be classified or grouped or clustered to form groupings that are assigned to each function 20 or the function embeddings 26 may be analyzed individually by the function parser 34 or the comparator 36 when a prompt 27 is required. When grouped, the group names may be processed to generate embeddings to enable groups to be compared to embeddings associated with the input 14.

At block 86, the comparator 36 may compare the information parsed from the input 14 with information parsed from the functions 20. For example, the input 14 may be parsed to create vector embeddings that may be used in a similarity search with vector embeddings of the functions 20 or the groups into which the functions 20 have been assigned or classified, grouped, clustered, etc.

At block 88, one or more functions 20 may be selected to generate the selections 37 for the application 12 (e.g., via the LLM interface module 38). It can be appreciated that the selections 37 may be a list of individually selected functions 20 or may include a block of functions 20 that are associated with a group or cluster of functions 20. The selections 37 may, additionally or alternatively, include a subset or a filtered list of functions 20 from a group. That is, the group may be identified in a first pass by the comparator 36 and the functions 20 from the first pass be subjected to a similarity search or may be subjected to a machine learning classifier to further reduce the selected number of functions 20. In this way, the comparison and selection process may be tuned to accommodate different limits imposed by the LLM 18 or limits based on the input 14. For example, the input 14 may require multiple recommendations and thus the selections 37 in that case may preferentially include a larger number of functions, depending on the limits of the LLM 18.

At block 90, the LLM interface module 38 may prepare the prompt 27 based on the selections 37. The prompt 27 may additionally include contextual information such as metadata associated with a chat message or contextual data provided by preceding messages or other parameters utilized by the application 12 when utilizing the LLM 18 for the purposes discussed herein. The prompt 27 may include the entire input 14 along with the function selections 37 and an instruction to recommend one of the function selections 37 based on the contents of the input 14.

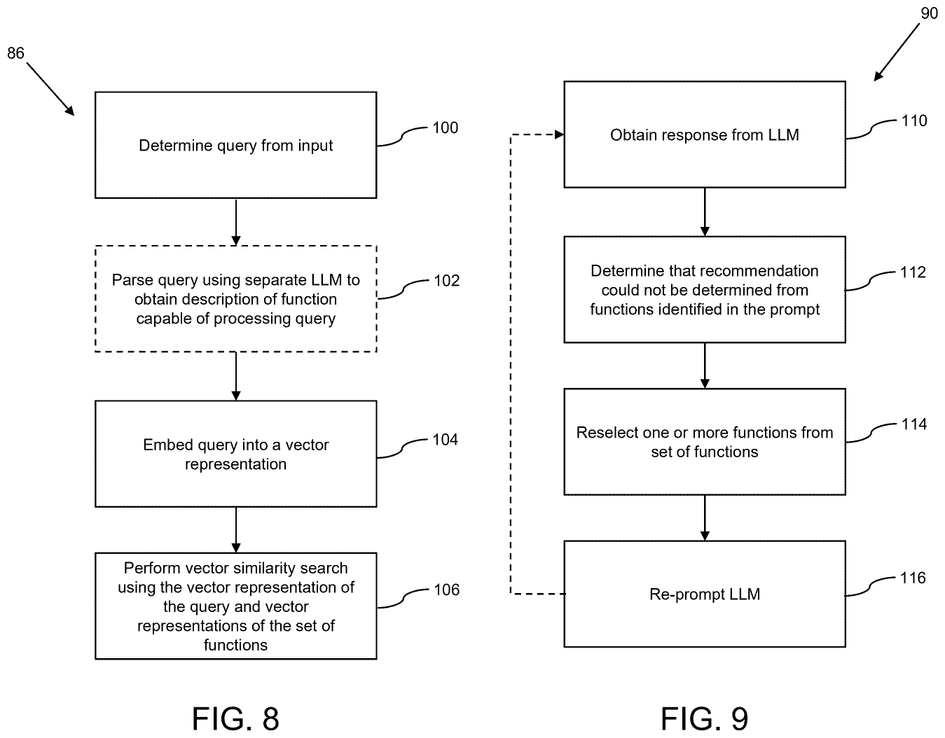

In FIG. 8, a flow chart is provided illustrating example operations for performing a comparison of information parsed from the input 14 with information parsed from the functions 20, e.g., in performing block 86 in FIG. 7.

At block 100, the input parser 32 may determine a query, such as a user query, that is in or is associated with the input 14. For example, the input 14 provided by the application 12 may include a request such as “how many of my orders are held up at the warehouse and haven't been shipped” in an e-commerce scenario.

At block 102, as an optional step, the query may be parsed by the input parser 32 using a separate LLM to obtain a description of a function 20 or functions 20 capable of processing the query. For example, the separate LLM may be trained on input queries for an e-commerce platform and access data that is internal to the platform to determine functions 20 that relate to “order status” or “shipping status”.

At block 104, whether block 102 is executed or not, the query may be embedded into a vector representation. This enables, at block 106, a vector similarity search of the query to be performed using the vector representation related to the input and vector representations of the functions 20. The result of the vector similarity search may include the “n” nearest function embeddings 36 based on the input 14 and this may be used to compile the selections 37 for generating the prompt 27.

In FIG. 9, a flow chart is provided illustrating example operations for handling a response 28 that may require re-prompting the LLM 18, e.g., at or following block 90 in FIG. 7.

At block 110, the LLM interface module 38 obtains the response 28 from the LLM 18 and, at block 112, determines that the recommendation sought in the prompt 27 could not be determined based on the functions 20 that were passed to the LLM 18 in the prompt 27.

At block 114, the LLM interface module 38 may instruct the comparator 36 to reselect one or more functions 20 from the set of functions 20. For example, the comparator 36 may have the input parser 32 and function parser 34 reparse the input 14 and the functions 20, e.g., using additional tools or techniques to either further filter the selections 37 or to select new functions 20. In one example, the initial pass may have selected functions 20 in one group of functions 20 and a different group may be selected for a second pass. In another example, instead of relying on groupings, the function parser 34 may evaluate each function 20 individually for the second pass.

At block 116, a new set of selections 37 may be returned to the LLM interface module 38 to have the LLM 18 re-prompted. As illustrated using a dashed line, the re-prompting may result in a further iteration of the method shown in FIG. 9, e.g., if a further pass is desired to obtain a recommendation prior to returning an error message.

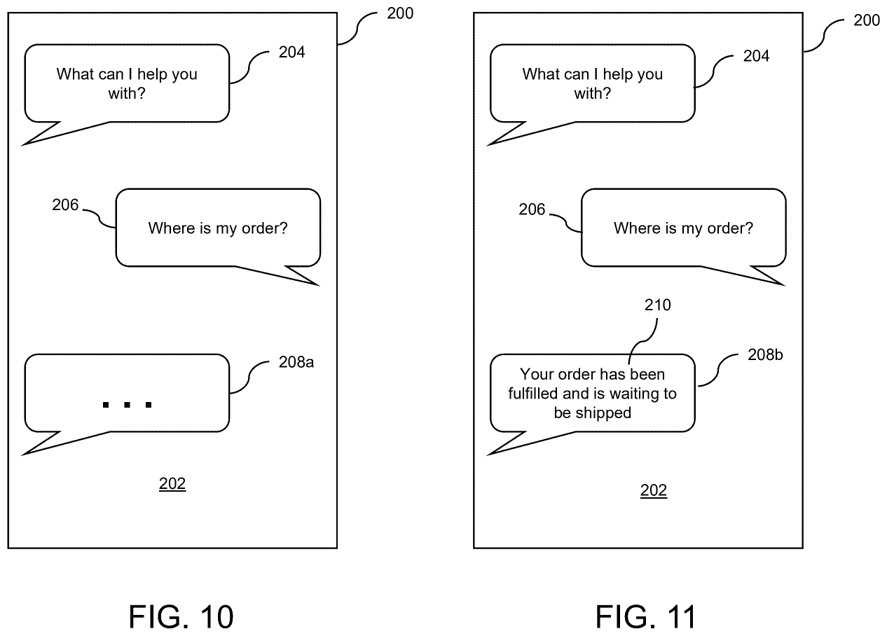

Referring now to FIG. 10, a message exchange user interface UI 200 is shown, e.g., for conducting a conversation with a chatbot that utilizes an LLM 18 to assist with queries, questions, or other requests. The UI 200 includes a messaging screen 202 that includes messages exchanged between parties. In this example, a first message 204 includes a question provided by a chatbot to illicit a conversation, namely: “What can I help you with?”. In response, a second message 206 is composed and sent by a correspondent, e.g., the user 24. In this example, the correspondent poses a question in response to the offer for help in the first message 204, namely: “Where is my order?”, which is a question that may be posed by a customer of an e-commerce platform. Here, the correspondent is using the chatbot to determine status information. The application 12 may thus provide this user query to the function selector 16 to utilize the LLM 18 to determine recommended function(s) 20 (e.g., tools) to obtain the status information.

The chatbot creates a pending message 208a with a series of dots to signify that it is obtaining an answer at which time, the process such as that shown in FIGS. 6 to 9 may be performed by the function selector 16, also illustrated in FIGS. 1 and 2.

As shown in FIG. 11, the pending message 208a may be transformed or converted into a responsive message 208b, which includes status information: “Your order has been fulfilled and is waiting to be shipped”. The status information in message 208b may be the result of a function call 30 that was recommended by the LLM 18. For example, the function selector 16 may pass a number of order-related functions 20 to the LLM 18 along with the user query to determine which order-related function 20 is appropriate to determine the location or stage in the shipping process that is being implied by the question posed by the user 24.

It can be appreciated that the responsive message 208b may include any information that is deemed to correct, that is, is found to not be erroneous to avoid errors being returned to the user 24. If the status information could not be found or is deemed to be erroneous, an error message may be provided indicating that the request could not be fulfilled. However, as shown in FIG. 9, the function selector 16 may utilize multiple prompts 27 to determine the recommendation function 20 and/or may try multiple function calls 30 in order to arrive at suitable status information.

A message exchange or conversation such as that shown in FIGS. 10 and 11 may be utilized in many other use cases. For example, a chatbot may be used by a programmer or developer to determine modules, commands or other data structures. Similarly, the chatbot may be used by an operator of a utility or service that needs to respond to events and queries the chatbot to determine a command, function, service or set of instructions that should be executed in response to that event. That is, the LLM 18 may be leveraged via a chatbot and the function selector 16 used to manage the number of functions 20 passed to the LLM 18.

With respect to the LLM 18, examples of generative models that may be used include, for example, OpenAI's Generative Pre-trained Transformer family (GPT 3.5, GPT 4, ChatGPT), Meta's Llama and Llama 2, CohereAl's Command, Mistral/Mixtral, Anthropic's Claude, Google's Gemini, Gemma and Bard. These general purpose and chat-focused models may be used as both the first and second model. It can be appreciated that, in addition, more specialized models may be used as the first or second model. For example, if the error in the first model is related to code generation then a generative model specializing in code generation may be used as the second model—the Code Llama, HuggingFace's CodeGen, Github Copilot's Codex model or similar may be used. In some cases, instead of text generation models, multimodal or multimedia models may be used such as BLIP-2, CLIP, or GPT-4V. These may be used to analyze user interfaces or user interface elements, or generate user interfaces or user interface elements.

It can be appreciated that although transformer-based language models are described herein, the present disclosure may be applicable to any ML-based language model, including language models based on other neural network architectures such as recurrent neural network (RNN)-based language models. Indeed, the consideration of an LLM 18 above is by way of example and the present disclosure and principles are not necessarily so limited. For example, the techniques described above may be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM 18 in it, may be employed in association with the above-discussed techniques.

### Neural Networks and Machine Learning

To assist in understanding the present disclosure, some concepts relevant to neural networks and machine learning (ML) are discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), RNNs, and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

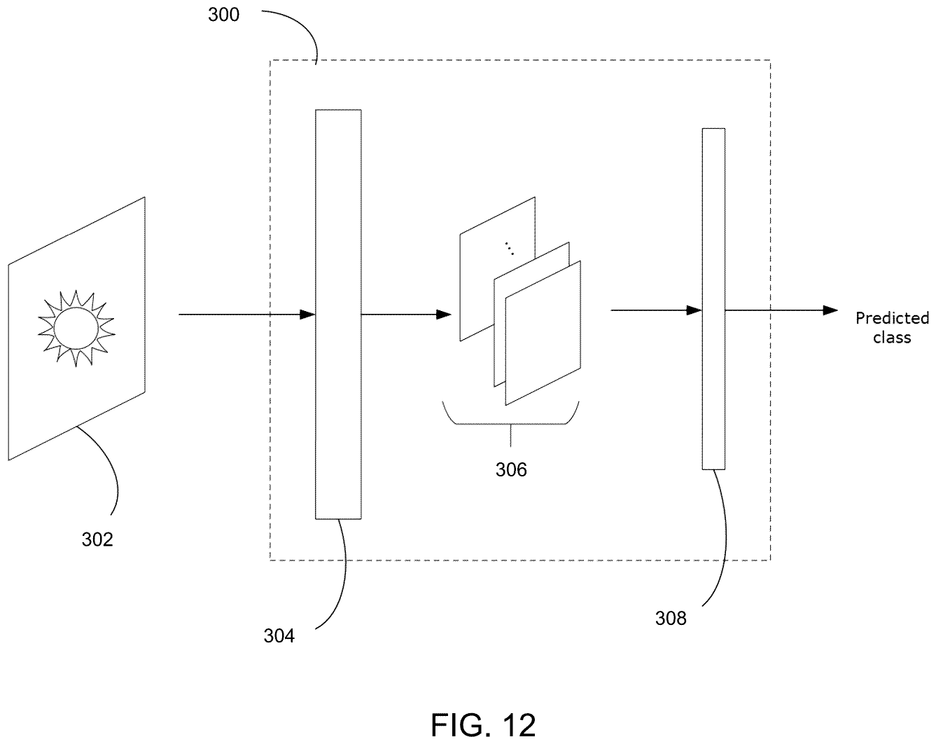

FIG. 12 is a simplified diagram of an example CNN 300, which is an example of a DNN that is commonly used for image processing tasks such as image classification, image analysis, object segmentation, etc. An input to the CNN 300 may be a 2D RGB image 302.

The CNN 300 includes a plurality of layers that process the image 302 in order to generate an output, such as a predicted classification or predicted label for the image 302. For simplicity, only a few layers of the CNN 300 are illustrated including at least one convolutional layer 304. The convolutional layer 304 performs convolution processing, which may involve computing a dot product between the input to the convolutional layer 304 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 304 is a set of feature maps 306 (sometimes referred to as activation maps). Each feature map 306 generally has smaller width and height than the image 302. The set of feature maps 306 encode image features that may be processed by subsequent layers of the CNN 300, depending on the design and intended task for the CNN 300. In this example, a fully connected layer 308 processes the set of feature maps 306 in order to perform a classification of the image, based on the features encoded in the set of feature maps 306. The fully connected layer 308 contains learned parameters that, when applied to the set of feature maps 306, outputs a set of probabilities representing the likelihood that the image 302 belongs to each of a defined set of possible classes. The class having the highest probability may then be outputted as the predicted classification for the image 302.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of an LLM may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

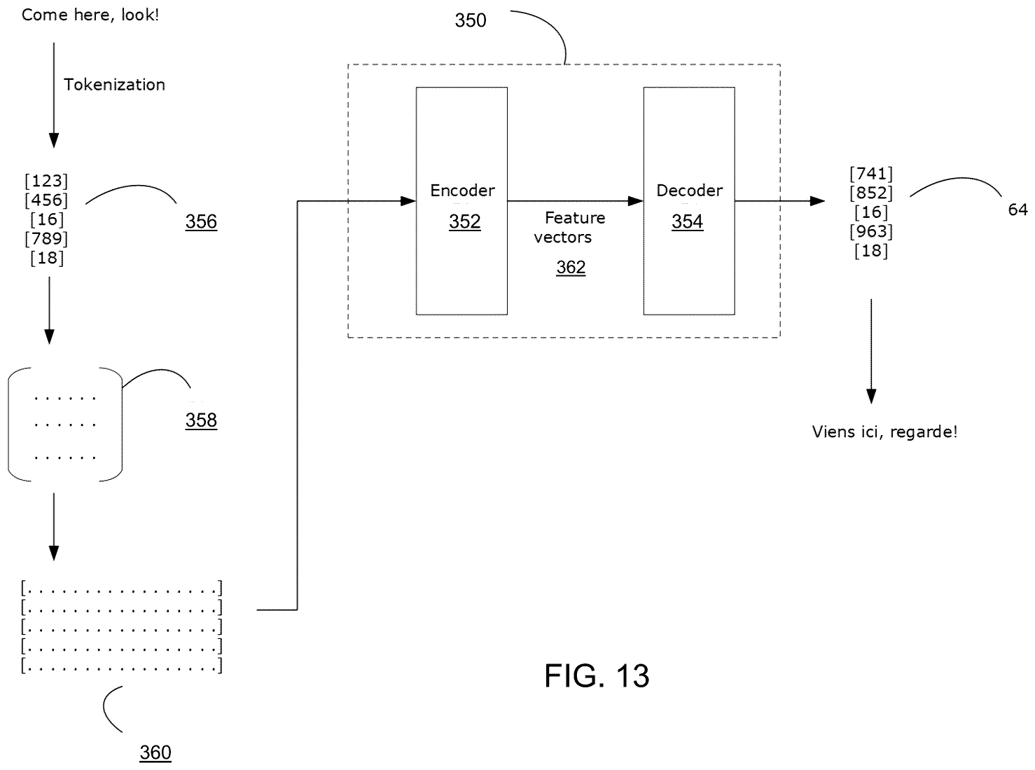

FIG. 13 is a simplified diagram of an example transformer 350, and a simplified discussion of its operation is now provided. The transformer 350 includes an encoder 352 (which may comprise one or more encoder layers/blocks connected in series) and a decoder 354 (which may comprise one or more decoder layers/blocks connected in series). Generally, the encoder 352 and the decoder 354 each include a plurality of neural network layers, at least one of which may be a self-attention layer. The parameters of the neural network layers may be referred to as the parameters of the language model.

The transformer 350 may be trained on a text corpus that is labelled (e.g., annotated to indicate verbs, nouns, etc.) or unlabelled. LLMs 18 may be trained on a large unlabelled corpus. Some LLMs 18 may be trained on a large multi-language, multi-domain corpus, to enable the model to be versatile at a variety of language-based tasks such as generative tasks (e.g., generating human-like natural language responses to natural language input).

An example of how the transformer 350 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 13, a short sequence of tokens 356 corresponding to the text sequence “Come here, look!” is illustrated as input to the transformer 350. Tokenization of the text sequence into the tokens 356 may be performed by some preprocessing tokenization module such as, for example, a byte pair encoding tokenizer (the “pre” referring to the tokenization occurring prior to the processing of the tokenized input by the LLM 18), which is not shown in FIG. 13 for simplicity. In general, the token sequence that is inputted to the transformer 350 may be of any length up to a maximum length defined based on the dimensions of the transformer 350 (e.g., such a limit may be 2048 tokens in some LLMs 18). Each token 356 in the token sequence is converted into an embedding vector 360 (also referred to simply as an embedding). An embedding 360 is a learned numerical representation (such as, for example, a vector) of a token that captures some semantic meaning of the text segment represented by the token 356. The embedding 360 represents the text segment corresponding to the token 356 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 360 corresponding to the “look” token will be closer to another embedding corresponding to the “see” token in the vector space, as compared to the distance between the embedding 360 corresponding to the “look” token and another embedding corresponding to the “cake” token. The vector space may be defined by the dimensions and values of the embedding vectors. Various techniques may be used to convert a token 356 to an embedding 360. For example, another trained ML model may be used to convert the token 356 into an embedding 360. In particular, another trained ML model may be used to convert the token 356 into an embedding 360 in a way that encodes additional information into the embedding 360 (e.g., a trained ML model may encode positional information about the position of the token 356 in the text sequence into the embedding 360). In some examples, the numerical value of the token 356 may be used to look up the corresponding embedding in an embedding matrix 358 (which may be learned during training of the transformer 350).

The generated embeddings 360 are input into the encoder 352. The encoder 352 serves to encode the embeddings 360 into feature vectors 362 that represent the latent features of the embeddings 360. The encoder 352 may encode positional information (i.e., information about the sequence of the input) in the feature vectors 362. The feature vectors 362 may have very high dimensionality (e.g., on the order of thousands or tens of thousands), with each element in a feature vector 362 corresponding to a respective feature. The numerical weight of each element in a feature vector 362 represents the importance of the corresponding feature. The space of all possible feature vectors 362 that can be generated by the encoder 352 may be referred to as the latent space or feature space.

Conceptually, the decoder 354 is designed to map the features represented by the feature vectors 362 into meaningful output, which may depend on the task that was assigned to the transformer 350. For example, if the transformer 350 is used for a translation task, the decoder 354 may map the feature vectors 362 into text output in a target language different from the language of the original tokens 356. Generally, in a generative language model, the decoder 354 serves to decode the feature vectors 362 into a sequence of tokens. The decoder 354 may generate output tokens 364 one by one. Each output token 364 may be fed back as input to the decoder 354 in order to generate the next output token 364. By feeding back the generated output and applying self-attention, the decoder 354 is able to generate a sequence of output tokens 364 that has sequential meaning (e.g., the resulting output text sequence is understandable as a sentence and obeys grammatical rules). The decoder 354 may generate output tokens 364 until a special [EOT] token (indicating the end of the text) is generated. The resulting sequence of output tokens 364 may then be converted to a text sequence in post-processing. For example, each output token 364 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs 18. An example GPT-type LLM 18 is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM 18, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an API). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM 18 may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM 18 may be referred to as a prompt, which is a natural language input that includes instructions to the LLM 18 to generate a desired output. A computing system may generate a prompt that is provided as input to the LLM 18 via its API. As described above, the prompt may optionally be processed or preprocessed into a token sequence prior to being provided as input to the LLM 18 via its API. A prompt can include one or more examples of the desired output, which provides the LLM 18 with additional information to enable the LLM 18 to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any entity within the computing environment 10 such as the computing device 22, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method comprising:
receiving an input for a large language model (LLM);
selecting one or more functions from a set of functions based on the input;
generating a prompt based on the input and the selected one or more functions; and
providing the prompt to the LLM and obtaining a response.

2. The method of claim 1, wherein the one or more functions are selected based on a limit associated with the input.

3. The method of claim 1, wherein the one or more functions are selected based on a limit associated with the LLM.

4. The method of claim 3, wherein the limit comprises a token input limit.

5. The method of claim 1, wherein the one or more functions are selected based on a limit associated with a number of functions.

6. The method of claim 1, wherein a total number of functions in the set of functions is above an input limit of the LLM.

7. The method of claim 1, wherein the selected one or more functions corresponds to a particular group of a plurality of groups of functions drawn from the set of functions.

8. The method of claim 7, wherein the plurality of functions are categorized into the plurality of groups using data associated with each function.

9. The method of claim 8, wherein the data associated with each function comprises a function definition.

10. The method of claim 7, wherein each of the functions in the set of functions comprises a vector representation generated using a text-to-vector embedding process.

11. The method of claim 10, wherein the plurality of groups are formed by clustering function embeddings.

12. The method of claim 11, wherein the plurality of groups are clustered using a vector similarity search.

13. The method of claim 1, further comprising parsing the input to determine information used in selecting the one or more functions.

14. The method of claim 13, wherein the input is parsed to determine one of a plurality of categories using a machine learning classifier.

15. The method of claim 13, wherein the input is parsed to determine one of a plurality of categories using a separate LLM.

16. The method of claim 13, wherein each of the functions in the set of functions has been parsed to enable that function to be selected as one of the one or more functions using the information.

17. The method of claim 16, wherein each of the functions in the set of functions has been parsed to determine one of a plurality of categories using a machine learning classifier or a separate LLM.

18. The method of claim 1, wherein the input comprises a user query associated with a task to be completed.

19. The method of claim 1, wherein the input comprises contextual data obtained from a chat conversation.

20. The method of claim 1, wherein each of the functions in the set of functions comprises a vector representation generated using a text-to-vector embedding process, and wherein the input comprises a query, the method further comprising:
embedding the query into a vector representation; and
performing a vector similarity search using the vector representation of the query and the vector representations of the set of functions.

21. The method of claim 20, wherein the query is parsed using a separate LLM to obtain a description of a function capable of processing the query, the description being used to embed the query into the vector representation.

22. The method of claim 1, wherein the response indicates that a recommended one of the selected one or more functions identified from the prompt could not be determined by the LLM, the method further comprising:
re-selecting one or more functions from the set of functions; and
re-prompting the LLM.

23. A computer system comprising:
at least one processor; and
at least one memory, the at least one memory comprising processor executable instructions that, when executed by the at least one processor, cause the computer system to:
receive an input for a large language model (LLM);
select one or more functions from a set of functions based on the input;
generate a prompt based on the input and the selected one or more functions; and
provide the prompt to the LLM and obtaining a response.

24. A computer-readable medium comprising processor executable instructions that, when executed by a processor of a computer system, cause the computer system to:
receive an input for a large language model (LLM);
select one or more functions from a set of functions based on the input;
generate a prompt based on the input and the selected one or more functions; and
provide the prompt to the LLM and obtaining a response.
